(19) United States
(12) Patent Application Publication
(10) Pub. No.: US 2026/0185900 A1
(43) Pub. Date: Jul. 2, 2026

(54) METHOD FOR DETECTING A DEFECT IN AT LEAST ONE GEAR OF AN AIRCRAFT TURBOMACHINE BASED ON A VIBRATORY SIGNAL OF THE GEAR

(71) Applicant: SAFRAN, Paris (FR)

(72) Inventors: Amadou ASSOUMANE, MOISSY-CRAMAYEL (FR); Yasmine HAWWARI, MOISSY-CRAMAYEL (FR); Dany ABBOUD, MOISSY-CRAMAYEL (FR); Yosra MARNISSI, MOISSY-CRAMAYEL (FR); Mohammed EL BADAOUI

(73) Assignee: SAFRAN, Paris (FR)

(21) Appl. No.: 18/859,923

(22) PCT Filed: May 9, 2023
(86) PCT No.: PCT/EP2023/062177

§ 371 Date: Oct. 24, 2024

(30) Foreign Application Priority Data
May 9, 2022 (FR) FR2204359

(51) Int. Cl. G01M 13/028; G01M 13/021

(52) U.S. Cl. CPC G01M 13/028; G01M 13/021

(57) ABSTRACT

The invention relates to a method for detecting a defect (DEF) in at least one gear of an aircraft turbomachine based on a vibratory signal (s(n)) of the gear, each gear having a determined meshing frequency (fc) corresponding to a carrier frequency, the method comprising steps consisting in estimating (E3) a target signal (x(n)) comprising a set of characteristic spectral lines based on a whitened vibratory spectrum (y(n)) obtained from a vibratory signal, the method comprising steps of determining, in the whitened vibratory spectrum (y(n)), a plurality of modulation blocks having a modulation index, each modulation block having a carrier coefficient that is dependent on a predetermined carrier frequency (fc) and on the modulation index and a plurality of modulation coefficients that are symmetric about the carrier coefficient.

### TECHNICAL FIELD

The present invention relates to the field of detecting a defect in a gear of an aircraft turbomachine from a vibratory signal from the gear.

It is known to measure a vibratory signal from a turbomachine and perform a spectral analysis to determine a signature characteristic of the presence of defects.

To be effective, this type of spectral analysis requires knowledge of the kinematics of the turbomachine in order to be able to monitor changes in the characteristic signature. Such a supervised approach is only possible when the characteristic signature is known “a priori”, i.e. the characteristic frequencies in the frequency spectrum. In practice, a priori knowledge of the kinematics of the turbomachine is not guaranteed.

To eliminate this disadvantage, it has been proposed to model the modulation phenomena of a gear by proposing a phenomenological model that determines for each type of gear defect the theoretical characteristic frequencies that may be determined in the frequency spectrum. In practice, such a phenomenological model is complex to determine and unreliable.

There is also a need to determine the gear modulations without knowing their periodicity, i.e. blindly, in order to reliably and accurately detect a gear defect over time.

In the prior art, an article XP93002238A of MDP1 from 2021 entitled “On the Use of Structured Prior Models for Baycsian Compressive Sensing of Modulated Signais” presents a method wherein the input is a signal sub-sampled in time.

The invention aims to eliminate at least some of these disadvantages.

### SUMMARY

The invention relates to a method for detecting a defect in at least one gear of an aircraft turbomachine based on a vibratory signal of the gear, each gear having a determined meshing frequency corresponding to a carrier frequency, the method comprising steps consisting in:
determining a vibratory spectrum from the vibratory signal,
whitening the vibratory spectrum so as to obtain a whitened vibratory spectrum,
estimating a target signal comprising a set of characteristic spectral lines based on the whitened vibratory spectrum,
determining at least one health indicator from at least one spectral line characteristic of the target signal,
comparing at least one health indicator to an indicator database so as to detect a defect,

The invention is remarkable in that, in order to estimate the target signal, the method comprises steps consisting in:
determining, in the whitened vibratory spectrum, a plurality of modulation blocks having a modulation index,
each modulation block comprising:
   a carrier coefficient which is a function of a predetermined carrier frequency and of the modulation index, and
   a plurality of modulation coefficients which are symmetrical about the carrier coefficient.

Thanks to the invention, the modulation coefficients may be estimated in a quasi-blind manner by exploiting their symmetrical structures, while being robust to measurement noise and periodicities that are not modulations. In this way, a relevant target signal is determined, which improves the detection of gear defects. Advantageously, the whitening step allows to reveal the symmetry hypotheses of the original signal so that they may be exploited.

Such symmetry assumptions may not be exploited in an undersampled input signal as taught in the article XP93002238A of MDPI of 2021 entitled “On the Use of Structured Prior Models for Baycsian Compressive Sensing of Modulated Signais”.

Preferably, the target signal is estimated using a Bayesian approach. On the one hand, this approach allows point estimators to be estimated automatically, but on the other, it also allows a complete a posteriori probability to be determined. This allows to calculate uncertainty biases.

Preferably, the modulation blocks are distinct from one another, in particular. disjoint. This allows to add an additional condition allowing to facilitate the estimation of modulation coefficients.

Preferably, the symmetrical modulation coefficients are jointly estimated. This allows to speed up the estimation by emphasising the symmetrical nature.

Preferably, the symmetrical modulation coefficients are estimated in the same position with respect to the carrier coefficient for each modulation block. In this way, we may take advantage of both intra-block and inter-block symmetry to determine the position of the modulation coefficients.

Preferably, the symmetrical modulation coefficients are considered to be realisations of a multivariate heavy-tailed distribution. This allows spectral peaks to be distinguished from noise. This is because a spectral peak has a heavy-tailed distribution (a distribution with a very low standard deviation). For noise, the distribution is more uniform across the spectrum. Such a distribution may therefore be used to distinguish a modulation peak from random noise in the spectrum.

Preferably, the whitened vibratory spectrum γ is defined by the following formula:

γ=φ⁻¹x+w
wherein:
φ is a Fourier transform φ^{†}φ=I_{N} and φ^{†} is the conjugate transpose of the matrix φ and I_{N} is the identity matrix of size N.
x∈C^{N} is the vector of unknown Fourier coefficients of the target signal x(n).
w is additive noise.

Preferably, the modulation coefficients comprise real and imaginary parts which follow a Gaussian distribution with mean zero and covariance matrix τγ_{q}Σ with.
γ_{q}≥0 is the mixing parameter according to a certain mixing distribution
Σ=Diag(v)⊗I₂∈R^{2B×2B} where ⊗ is the Kronecker product, I₂ the identity matrix of size 2×2 and v=[v_{I}, . . . , v_{B}]^{T}∈(R⁺)^{B}.

The global variables v_{b} adapt the underlying parsimony in the modulation block: small appropriate values of v_{b} may lead to an excessive shrinkage of the active coefficients, particularly those with small amplitudes

Preferably, the modulation blocks are in the form of hierarchical models with

$$\begin{matrix}∀ b ∈ \{ 1 , … , B \} , & & {v}_{b} \sim IG ( \text{?} , {β}_{b} ) \\ ∀ q ∈ \{ 0 , … , Q \} , & \sqrt{{γ}_{q}} \vert {ϕ}_{q} \sim {C}^{+} ( 0 , \sqrt{{ϕ}_{q}} ) , & \sqrt{{ϕ}_{q}} \sim {C}^{+} ( 0 , 1 )\end{matrix}$$

$$\text{?} \text{indicates text missing or illegible when filed}$$

where IG(α_{b}, β_{b}) is the inverse Gamma distribution with positive constant parameters α_{b} and β_{b} C⁺(0, e) is the Cauchy half distribution with locus 0 and scale e.

The use of half-Cauchy priority for local and global parameters is recommended to improve the shrinkage. The inverse Gamma distribution is also appropriate given that its density disappears at the origin, which artificially distances the values of v_{b} from zero. On the other hand, it is a conjugate density for the Gaussian distribution, which makes the calculation easier.

Preferably, the vector of the carrier coefficients is determined with a Gaussian prior such that x₀˜CN(0, τγ₀Diag(v)) where γ₀>0.

This allows to avoid zero values of v_{b}, if the active group b proves to be very parsimonious.

### PRESENTATION OF DRAWINGS

The invention will be better understood on reading the following description, given by way of example, with reference to the following figures, given by way of non-limiting examples, wherein identical references are given to similar objects.

FIG. 1 is a schematic representation of a method for detecting a defect of a gear according to an example of implementation of the invention.

FIG. 2 is a schematic representation of a vibratory spectrum and a whitened vibratory spectrum in logarithmic scale.

FIG. 3 is a close-up schematic representation of the whitened vibratory spectrum in linear scale.

FIG. 4 is a schematic representation of the modulation block estimation step.

FIG. 5 is a schematic representation of the coefficients of a modulation block.

FIG. 6 is a schematic representation of a whitened vibratory spectrum with estimated modulation blocks in an initial experiment.

FIG. 7 is a close-up schematic representation of a whitened vibratory spectrum at the level of the second modulation block in [FIG. 6],

FIG. 8 is a schematic representation of a whitened vibratory spectrum with estimated modulation blocks in a second experiment.

FIG. 9 is a close-up schematic representation of the whitened vibratory spectrum of [FIG. 8],

FIG. 10 is a schematic representation of a whitened vibratory spectrum measured on day 1 during a third experiment.

FIG. 11 is a schematic representation of a whitened vibratory spectrum measured on day 12 during a third experiment.

FIG. 12 is a close-up schematic representation of [FIG. 10].

FIG. 13 is a close-up schematic representation of [FIG. 11].

FIG. 14 is a schematic representation of the evolution of the index over time.

It should be noted that the figures set out the invention in detail in order to implement the invention, said figures may of course be used to better define the invention if necessary.

### DETAILED DESCRIPTION

The invention relates to a method for detecting a defect in at least one gear of an aircraft turbomachine based on a vibratory signal of the gear.

The vibratory signal may be measured by a vibration or force sensor mounted in the turbomachine. The measurement signal may be purely vibratory or vibratory-acoustic.

The invention will be presented for the case of a single gear, but it applies more generally to several gears, in particular, a gear train of a turbomachine accessory gearbox.

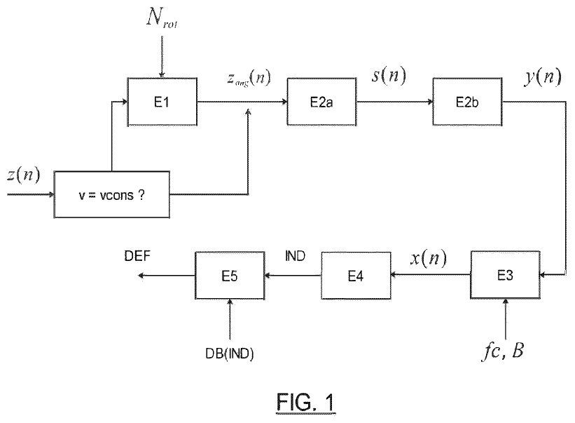

According to the invention, with reference to [FIG. 1], the method comprises the known steps consisting in:
determining E2a a vibratory spectrum z(n) from the vibratory signal s(n),
whitening E2b the vibratory spectrum z(n) to obtain a whitened vibratory spectrum γ(n),
estimating E3a target signal x(n) comprising a set of characteristic spectral lines from the whitened vibratory spectrum γ(n),
determining E4 at least one health indicator IND from at least one spectral line characteristic of the target signal x(n), and
comparing E5 at least one health indicator IND to an indicator database DB(IND) so as to detect a defect DEF.

In this example, the vibratory signal s(n) is sampled at a sampling frequency fs to obtain n samples (n varying from 1 to N).

Using the method described in the invention, health indicators IND relevant to detecting a gear defect DEF are accurately determined.

Estimating the target signal x(n), comprising a set of characteristic spectral lines, from the whitened vibratory spectrum y(n) is complex to achieve in a quasi-blind manner. In the present invention, only the meshing frequency fc specific to the gear, hereinafter referred to as the carrier frequency fc, is known.

The various steps in the method are described below.

### Recalibrate E1 the Vibratory Signal

In this example, with reference to [FIG. 1], the method comprises an optional preliminary step consisting of recalibrating the vibratory signal s(n) if the speed of rotation of the gear Nᵣₒₜ is not constant. In this case, the vibratory signal s(n), acquired in the time domain, is resampled to obtain a vibratory signal s_{ang}(n) recalibrated in angle if the speed v of the gear is not stationary, i.e. not constant. This step requires prior knowledge of the gear's rotation frequency Nᵣₒₜ. The latter is estimated, for example, by means of a position sensor on a shaft of the gear. If the speed is constant (v=vcons), the vibratory signal s(n) may be directly transformed into a vibratory spectrum z(n).

Determining E2a a Vibratory Spectrum from the Vibratory Signal

A vibratory spectrum z(n) is determined from the vibratory signal s(n) (or the recalibrated vibratory signal s_{ang}(n)) using a known method, for example a Fourier transform, as described below.

Whitening E2b the Vibratory Spectrum z(n) to Obtain a Whitened Vibratory Spectrum y(n)

When the vibratory signal s(n) is measured, it is generally filtered by a mechanical transfer function linked to the transmission between the excitation sources and the sensor. This transfer function affects the shape of the vibratory spectrum z(n) and may alter the various characteristic properties which govern the modulations and which we wish to use in this invention.

The method also comprises a step consisting of whitening the vibratory spectrum z(n) to attenuate the effect of the transfer function related to the transmission. To whiten the vibratory spectrum z(n), an inverse transfer function is determined and applied to the vibratory spectrum z(n) so as to compensate for the transmission-related transfer function. In other words, the effects of the transmission on the vibratory spectrum z(n) are eliminated so that the modulations may be highlighted, as will be shown later.

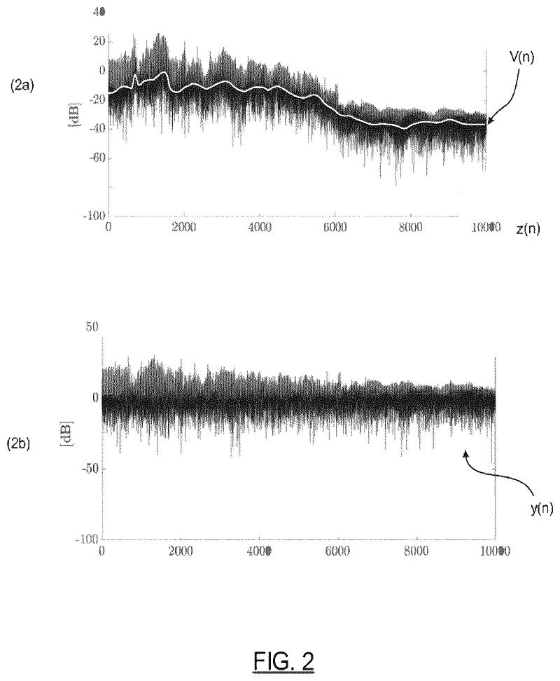

Several methods are known for determining the inverse transfer function. For example, a method referred to as “equalisation correction” method consists of determining a baseline of the spectrum V(n) (white line on the curve 2a in FIG. 2), for example by using a median filter or parametric approaches. Next, the vibratory spectrum z(n) is normalised to obtain a whitened spectrum y(n)=s(n)/V(n), also referred to as the “flat spectrum y(n)”.

FIG. 1 shows the original spectrum s(n) and the baseline spectrum V(n). FIG. 2 shows the whitened spectrum y(n).

Estimating E3a Target Signal x(n) Comprising a Set of Characteristic Spectral Lines from the Whitened Vibratory Spectrum y(n)

The determination of characteristic spectral lines from the whitened vibratory spectrum y(n) is complex, particularly in a blind manner. In this case, even for a blind determination, certain properties of the characteristic spectral lines remain known.

In practice, the spectral lines are identifiable from the noise in the whitened vibratory spectrum y(n) since their value is generally greater than the noise. Such a whitened vibratory spectrum may thus be approximated as a set of families of carrier frequencies (a fundamental frequency and its multiples) and a set of modulation blocks (a carrier and its modulations).

As illustrated in [FIG. 4], the step E3 of estimating the target signal x(n) comprises a step consisting in determining, in the whitened vibratory spectrum y(n), a plurality of modulation blocks BMb having a modulation index b varying between 1 and B.

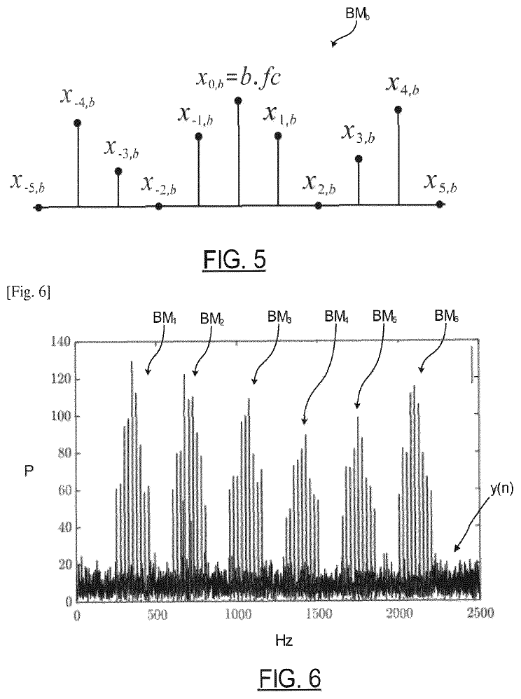

With reference to [FIG. 5], each modulation block BMb comprises:
a carrier coefficient x_{0,b}(x_{0,b}=b*fc) which is a function of the predetermined carrier frequency fc and the index b of the modulation block BM_{b}, and
a plurality of modulation coefficients which are symmetrical αbout the carrier coefficient x_{0,b}.

Modelling by modulation blocks BM_{b} is relevant because the gears are the mechanical elements that exhibit the most modulation phenomena. According to Fourier series decomposition, the contact between the toothed wheels of a gear is expressed by the meshing frequency fc and its harmonics. A gear is subject to several types of defect, such as machining defect, non-uniform spacing defect between the teeth or the irregularities in the contact surface of the teeth. During operation of the gear, other defects may appear, such as the defect of removal of material from a tooth. If the defect is linked to an uneven distribution of stiffness along the tooth surface, periodic amplitude modulations appear. If the defect is linked to a change in the meshing period (which may be associated with a change in the spacing between the teeth), phase modulations appear. It is important to note that the amplitude modulations induce perfectly symmetrical spectral lines, which is different from phase modulations.

Overall, the set of lines is therefore globally symmetrical due to the dominance of amplitude modulations. It is therefore appropriate to define a modulation block BM_{b} comprising a plurality of modulation coefficients symmetrical about the carrier coefficient x_{0,b}.

The modulation block BM_{b} is then considered to be “parsimonious”, since the carrier coefficient x_{0,b} and the modulation coefficients are represented by lines that are distinct from one another. This allows to avoid having a result that is not constrained by a structure, noise and so on.

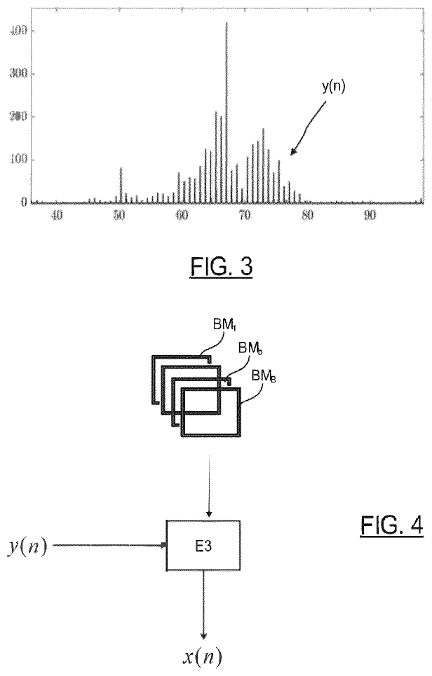

FIG. 2 shows a whitened vibratory spectrum y(n) on a logarithmic scale. [FIG. 3] is a close-up view of the whitened vibratory spectrum y(n) of [FIG. 2] on a linear scale so as to illustrate the modulations of the meshing frequency fc of the gear by defect frequencies.

In the following, the whitened vibratory spectrum y(n) is defined by the following formula:

$$y = {Φ}^{- 1} x + W$$

wherein
y is the whitened vibratory spectrum
φ is a normalized Fourier transform

$${ϕ}_{k , n} = \frac{1}{\sqrt{N}} \text{?} {ϕ}^{†} ϕ = {I}_{N}$$

$$\text{?} \text{indicates text missing or illegible when filed}$$

and
φ^{†} is the conjugate transpose of the matrix φ and I_{N} is the identity matrix of size N.
x∈C^{N} is the vector of coefficients of the “target signal x”.
w is additive noise.

The Fourier coefficients x are defined according to the following formula x=φS with {s(n)}_{{n=1, . . . N}} the periodically modulated vibratory signal.

As mentioned previously, the target signal x(n) comprises harmonics of the meshing frequency fc and modulations. The target signal x(n) represents the modulations in the spectral domain. Preferably, the target signal x(n) is estimated using a Bayesian approach. On the one hand, this approach allows point estimators to be estimated automatically, but on the other, it also allows a complete posteriori probability a to be determined. This allows to calculate uncertainty biases, as will be shown later.

In the following, the additive noise coefficients w are assumed to be independent and identically distributed Gaussian variables (iid) of unknown variance τ>0. The distribution density of the observations is then given by the following formula:

$$p ( y \vert x , τ ) = ( 2 π τ \text{?} exp ( - \frac{\text{?}}{2 θ} )$$

$$\text{?} \text{indicates text missing or illegible when filed}$$

Subsequently, the variance

$$τ \qquad [ Math 3 ]$$

and the target signal x will be estimated together. Subsequently, the variance

$$τ \qquad [ Math 3 ]$$

and the target signal x are linked by a non-informative a priori Jeffrey's law

$$τ \qquad [ Math 3 ]$$

$$p ( τ ) ∝ {τ}^{- 1} \qquad [ Math 3 ]$$

Preferably, as will be shown later, the modulation blocks BM_{b} are in the form of hierarchical models because they offer a great flexibility for taking into account the structures of the parsimonious coefficients by means of latent variables.

Therefore, given that the carrier frequency fc is known, the target signal x may be modelled as a set of modulation blocks BM_{b} whose positions are partially known. In practice, the central position of the modulation blocks BM_{b} is known and is equal to the carrier frequency fc multiplied by the modulation index b. The positions of the modulation coefficients within the modulation blocks BM_{b} are unknown.

Preferably, only some of the modulation coefficients around the carrier frequency fc and its integer multiple harmonics are non-zero, and the other modulation coefficients may be regarded as zero. In addition, the position of the non-zero modulation coefficients around the different harmonics of the carrier frequency fc remains almost identical.

Hereafter, B is the number of harmonics in the carrier, i.e. the number of modulation blocks BM_{b} (b varying between 1 and B). Each modulation block BM_{b} is centered on the harmonic b*fc. As previously stated, it is assumed that the modulation blocks are symmetrical, i.e. each modulation block BM_{b} contains the same number Q of coefficients on the left and right sides of the carrier coefficient centered on the harmonic b*fc as shown in [FIG. 5].

Preferably, it is also assumed that the modulation blocks BM_{b} are spaced apart, i.e. do not overlap. This is the case for gears because the carrier frequency fc is very large compared with the fundamental modulation frequencies.

Hereafter, A is the union of all modulation blocks BM_{b} (card A)=B(2Q+1)). This means that we assume at most B(2Q+1) non-zero coefficients (B harmonics of the carrier (carrier coefficients) and 2Q non-zero coefficients around each carrier (modulation coefficients)).

As mentioned above, the number of non-zero modulation coefficients around each carrier is in practice much less than 2Q. Let Ā be the set of nuisance modulation coefficients. For all k∈Ā, xₖ=0. In the following, for all b∈{1, . . . , B}, we denote by x_{0,b} the carrier coefficient on the frequency b. f_{c} and for all q∈{1, . . . , Q], we denote by x_{-q,b} and x_{qb} the q^{th} coefficients of modulation respectively located to the left and to the right of b*fc as illustrated in [FIG. 5].

Preferably, each modulation coefficient x_{q,b} may be easily obtained from the target signal x by applying an appropriate sparse matrix P_{q,b} containing an appropriate row of a permutation matrix, i.e. X_{q,b}=P_{q,b}X

As mentioned previously, the target signal x is modulated around the carrier frequency and its harmonics. In order to exploit the symmetry of the modulation coefficients in each modulation block BM_{b}, the method comprises a step of jointly estimating the symmetrical modulation coefficients X_{q,b} and X_{q,b}, i.e. belonging to frequency bins which are symmetrical with respect to the b^{th} harmonic of the carrier frequency b*fc. To this end, we define the vector X_{q,b}∈C² where.

$$∀ b ∈ [ 1 , … , B \} ∀ q ∈ \{ 1 , … , Q \} , {x}_{q , b} = [ {x}_{- q , b} , {x}_{q , b} ]$$

To make the most of the similarities between the modulation blocks BM_{b}, the modulation coefficients are determined in the same position relative to the harmonics of the carrier.

To do this, the coefficients of all the modulation blocks BM_{b} at the same position and their symmetries with respect to the harmonics of the carrier b*fc are stacked to construct multi-block coefficient vectors of size 2B.

$$∀ q ∈ \{ 1 , … , Q \} , {x}_{q} = {[ {x}_{q , 1}^{T} , … , {x}_{q , B}^{T} ]}^{T}$$

Wherein

$${x}_{q , 1}^{T} \qquad [ Math 4 ]$$

is the transposition of the vector

$${x}_{q , 1} \qquad [ Math 4 ]$$

Also referred to as

$${x}_{0} \qquad [ Math 4 ]$$

the vector of size B containing the coefficients of the harmonics of the carrier B (carrier coefficients). The parsimony of the spectrum and the dependencies between the Fourier coefficients are captured by assuming that

$${( {x}_{q} )}_{1 \leq q \leq Q} \qquad [ Math 4 ]$$

are realisations of a multivariate heavy-tailed distribution. It is considered the multivariate Gaussian (SMG) scale mixture class.

$$∀ q ∈ \{ 1 , … , Q \} , {x}_{q} ∼ CN ( 0 , {γ}_{q} \sum ) \qquad [ Math 5 ]$$

Where

$$CN \qquad [ Math 5 ]$$

here refers to the multivariate complex normal distribution. The covariance matrix is real-valued.

The modulation coefficients X_{q} comprise real and imaginary parts which follow the Gaussian distribution with mean zero and covariance matrix τγ_{q}Σ.

γ_{q}≥0 is the mixing parameter according to a certain mixing distribution and Σ=Diag(v)⊗I₂∈R^{2B×2B} where denotes the Kronecker product. I₂ the identity matrix of size 2×2 and v=[v_{I}, . . . , v_{B}]^{T}∈(R⁺)^{B}.

A Gaussian prior is also assumed for the vector of carrier coefficients, i.e. x₀˜CN(0, τγ₀Diag(v) where γ₀>0. It should be noted that, although a diagonal covariance matrix has been considered, the coefficients of X_{q} are uncorrelated but still dependent.

The variable v_{b} acts as a global indicator of the overall magnitude of harmonics in the active block b, while the local variable γ_{q} controls the parsimony within blocks. If γ_{q} is too small, the coefficients of the spectrum in the position q and those in their symmetrical positions with respect to the harmonics of the carrier across the different active groups B approach zero. Conversely, if γ_{q} is high, all the coefficients at the positions q and −q around the carrier harmonic in any modulation block BM_{b} with non-zero v_{b}, are also non-zero and therefore have a high probability of belonging to modulations. It follows that the parsimony within modulation blocks BM_{b} is ensured if almost all γ_{q} are close to zero.

It should be noted that the model favours the structure of the spectrum by the dependence it introduces between the amplitudes of the coefficients in relation to their position relative to the harmonics of the carrier. This dependency may be interpreted as follows: the coefficients located in identical or symmetrical positions with respect to their carrier frequency contribute almost equally to the overall energy of the modulation block BMb in which they are located.

The definition of global and local parameters in the parsimonious block model is very important. In this example, we propose the following hierarchical model for these parameters:

$$∀ b ∈ \{ 1 , … , B \} , {v}_{b} ∼ IG ( {α}_{b} , {β}_{b} )$$

$$∀ q ∈ \{ 0 , … , Q \} , \sqrt{{γ}_{q}} \vert {ϕ}_{q} ∼ {C}^{+} ( 0 , \sqrt{{ϕ}_{q}} ) , \sqrt{{ϕ}_{q}} ∼ {C}^{+} ( 0 , 1 )$$

where IG(α_{b}, B_{b}) is the inverse Gamma distribution with positive constant parameters α_{b} and β_{b} and C⁺ (0,e) is the Cauchy half-distribution with locus 0 and scale e.

Such a hierarchical model has many advantages. The global variables v_{b} adapt the underlying parsimony in the modulation block: appropriate small values of v_{b} may lead to an excessive shrinkage of the active coefficients, particularly those with small amplitudes. We therefore preferred to define its anteriority so as to avoid vanity values v_{b} if the active group b turns out to be very sparse.

This is motivated by our assumption of a known number of carrier harmonics, i.e. that in each modulation block BM_{b} there is at least one non-zero modulation coefficient.

The use of half-Cauchy priority for local and global parameters is recommended to improve the shrinkage. Nevertheless, it was found during the experiments that the half-Cauchy priority for the global parameters may worsen the reconstruction of small lines compared with the inverse Gamma distribution. The inverse Gamma distribution is appropriate given that its density disappears at the origin, which artificially distances the values of v_{b} from zero. On the other hand, it is a conjugate density for the Gaussian distribution, which will make the calculation easier later on.

On the other hand, in contrast to global scales, we prefer local variables v_{b} to have vanity values in order to model ultra-parsimonious signals appropriately. This is achieved by using the Cauchy half-priority which, in addition to having tails similar to those of Cauchy, has the merit, compared with the inverse Gamma, of being non-zero at v_{b}=0. This allows the x_{q} priority to have an infinitely high peak at the origin, giving good shrinkage properties. The hyperparameter φ_{q} offers another degree of freedom in mixing the priorities of γ_{q}.

Finally, the half-Cauchy priority does not bring any additional difficulty in the posterior inference compared to the inverse Gamma using the parameter expansion trick.

Using the detection method described in the invention, the characteristic lines forming the target signal x(n) may be accurately estimated.

In practice, the person skilled in the art knows the kinematics of the gear and may define a priori the sources that will contribute to the measured vibratory signal. For example, for a planetary gear, you are expected to identify the known frequencies of the various rotating members of the gear (sun gear, planet gear, ring gear) and/or (unknown) linear combinations of these known frequencies in the spectrum around the meshing frequencies. These frequencies are referred to below as “expected frequencies”.

To define the size of a modulation block, it is advantageous to define an upper limit on these expected frequencies. This allows to define the size of the modulation block surrounding the frequency of the carrier. After estimating the spectrum of the target signal, in order to monitor a specific rotating member (for example a planet gear), it is sufficient to extract the energy of all the sidebands that are linked to the frequency expected of this specific rotating member.

Determining (E4) at Least One Health Indicator (IND) from at Least One Spectral Line Characteristic of the Target Signal (x).

With reference to [FIG. 1], after the target signal x(n) has been obtained, one or more health indicators IND may be calculated from one or more spectral lines characteristic of the target signal x(n). For example, a health indicator IND might be the Sideband Energy Ratios (SER). It is defined as follows:

$$SER = \frac{Modulation E nergy}{Energy of the harmonics of fc}$$

This health indicator IND is interesting because it is standardised and shows the evolution of the harmonics and of the modulations together. In the event of a defect, for example, the energy of the carrier frequency fc may decrease while the modulations increase.

If global monitoring is desired (without exploiting the kinematics), the maximum size of the modulation block may be set in the estimation phase.

A global indicator SERG may then be calculated on the signal obtained.

$$SERG = \frac{Energy i n all the blocks surrounding the frequency}{Energy of the harmonics of fc}$$

The overall indicator will be noisier because it contains all the sources, but it will still allow a defect to be detected because a defect increases the overall energy of the modulations. However, it may not be used to locate the defect. To locate it, you need to know the frequencies of the various rotating members.

Comparing (E5) at Least One Health Indicator (IND) with an Indicator Database (DB(IND)) so as to Determine a Defect (DEF).

The health indicator IND is then compared with an indicator database DB(IND) to determine a defect DEF. For a health indicator of the SER type, the indicator database DB(IND) comprises a health threshold, for example. It goes without saying that the indicator database DB(IND) could also comprise reference health indicators.

Using the method described in the invention, a target signal x(n) is reliably estimated in a blind manner in order to reactively detect gear defects and thus avoid any malfunction.

Some experimental results are then presented.

### Experiment 1

In a first experiment, the vibratory signal s(n) is a signal resulting from a simulation and has the following characteristics:

$$N = 5 , 000 ,$$

$$B = 6.$$

fₛ=5000, fs is the sampling frequency
6 modulations,

$${f}_{c} = 350 / {f}_{s} , {f}_{m} = 25 / {f}_{s} .$$

The vibratory signal s(n) was generated by multiplying 2 periodic signals (s=s_{c}×sₘ) and a Gaussian noise was added. The whitened vibratory spectrum y(n), derived from the vibratory signal s(n), is shown in [FIG. 6].

During the step of estimating the target signal x(n), 6 modulation blocks BM₁-BM₆ (vertical lines in grey) were identified, each consisting of the frequency b*fc (carrier coefficient) and amplitude and phase modulations with different amplitudes (modulation coefficients). As shown above, this results in a symmetrical structure in terms of location on the frequency axis, but not amplitude. In this first experiment, the modulation blocks BM₁-BM₆ were detected without noise with a very low MSE (Mean Squared Error) of around 0.04. Advantageously, the modulations are reconstituted without taking the Gaussian noise into account, given that it is non-parsimonious and non-symmetrical in frequency. This provides an important gain to form relevant health indicators IND.

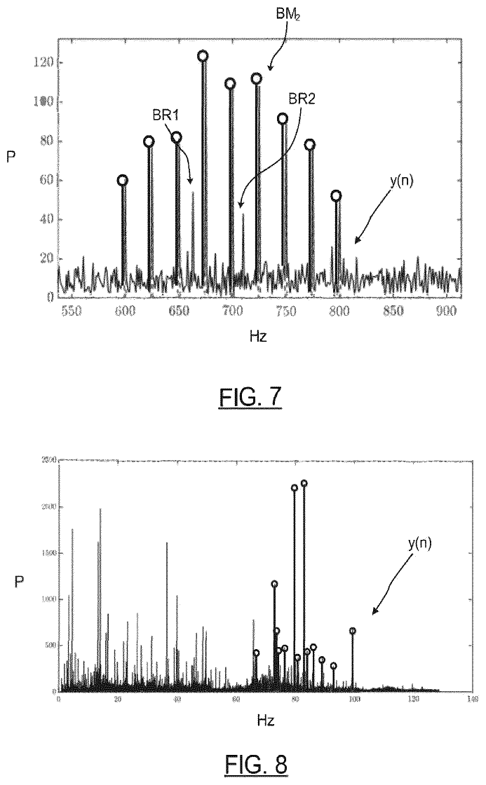

With reference to [FIG. 7], which shows a close-up of the whitened vibratory spectrum y(n) at the level of the second modulation block BM₂, we may see that there are two harmonic noises BR1, BR2 at different frequencies. The blind determination presented by the present invention is resistant to these harmonic noises BR1, BR2. By taking into account inter-block symmetries (modulation coefficients within a single modulation block) and intra-block symmetries (identical symmetries between several modulation blocks), it is possible to exclude lines that are not modulations, such as the harmonic noises BR1 and BR2.

### Experiment 2

In a second experiment, with reference to [FIG. 8], the vibratory signal s(n) is a signal resulting from an actual vibratory measurement carried out on an aircraft turbomachine comprising a planetary gear. This type of gear has modulations in its healthy state that are amplified or complemented by new modulations in the event of a defect. [FIG. 8] shows the estimated modulation blocks around the 8th-order meshing frequency fc.

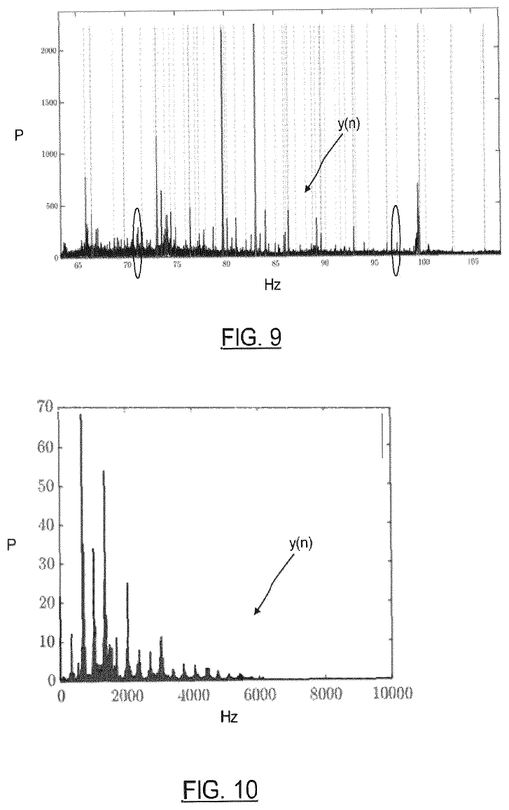

FIG. 9 is a close-up representation wherein the modulations of the sun gear pinion, of the planet gear pinion and of the low-pressure shaft are correctly estimated. The modulations are very well estimated with a strong attenuation of the noise at the moment of non-estimation of the modulations. Circles have been added to show that even if peaks exist within a modulation block, they have not been recovered because these peaks do not have a symmetrical structure and are therefore not modulation coefficients.

### Experiment 3

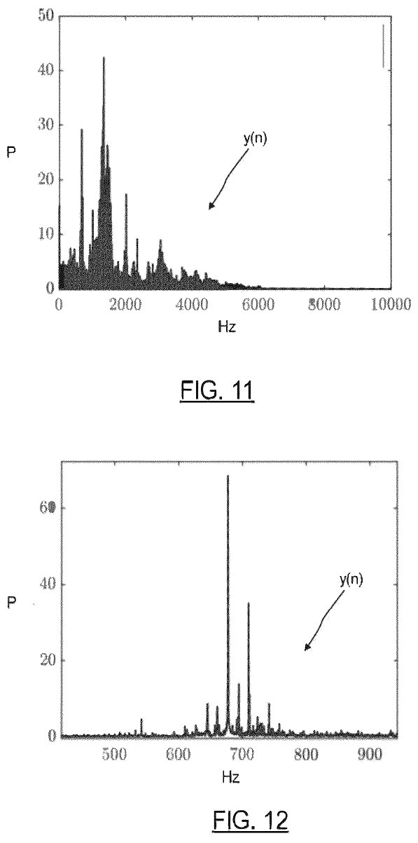

In a third experiment, the vibratory signal s(n) is a 3-second signal from a spur gear acquired with a sampling frequency fₛ=20 KHz. In this example, the vibratory signal s(n) has a carrier frequency f_{c}=388 Hz. The vibratory signal s(n) was measured on different days, in particular on day 1 ([FIG. 10]) and on day 12 ([FIG. 11]).

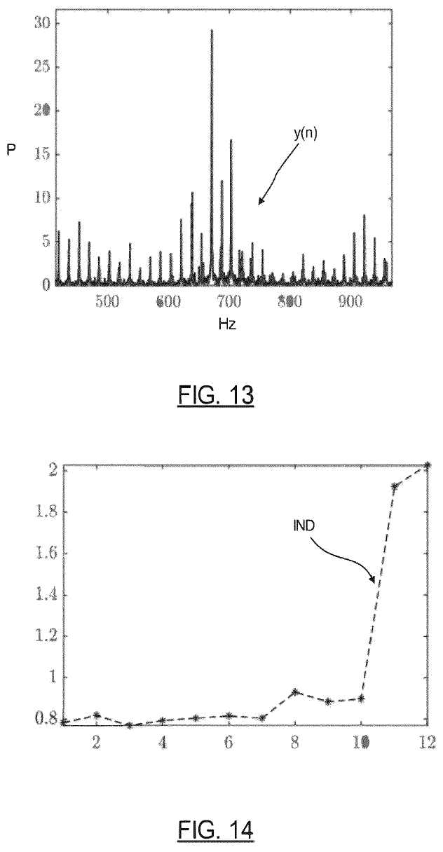

When we compare the changes between day 1 (FIG. 10) and day 12 (FIG. 11), we see a remarkable amplification and multiplication of the harmonics on the close-up views of FIG. 12 (day 1) and FIG. 13 (day 12). The modulations of around 2fc per harmonic indicate a defect at the level of the pinion. The modulations are perfectly determined using the detection method described in the invention.

A health indicator IND was calculated every day for 12 days. In this example, the health indicator IND is based on the energy of the modulations (in frequency). [FIG. 14] represents the change in the health indicator IND over time. We may thus determine that the gear was free of defects until the appearance of a moderate defect on day 8 (chipping of a gear tooth) before the appearance of a severe defect on day 11 (partial removal of a tooth).

In this way, the quality of the determination of the target signal x(n) allows to form health indicators IND which are accurate and therefore highly relevant for the reactive detection of a defect.

1-10. (canceled)

11. A method for detecting a defect in at least one gear of an aircraft turbomachine based on a vibratory signal of the gear, each gear having a determined meshing frequency corresponding to a carrier frequency, the method comprising steps consisting in:
Determining a vibratory spectrum from the vibratory signal,
Whitening the vibratory spectrum so as to obtain a whitened vibratory spectrum (y(n)),
Estimating a target signal comprising a set of characteristic spectral lines based on the whitened vibratory spectrum,
Determining at least one health indicator from at least one spectral line characteristic of the target signal,
Comparing at least one health indicator to an indicator database so as to detect a defect.
the method wherein, to estimate the target signal, the method comprises steps consisting in:
Determining, in the whitened vibratory spectrum, a plurality of modulation blocks having a modulation index,
Each modulation block comprising:
a carrier coefficient which is a function of a predetermined carrier frequency and of the modulation index, and
a plurality of modulation coefficients which are symmetrical αbout the carrier coefficient.

12. The method according to claim 11, wherein the target signal is estimated using a Bayesian approach.

13. The method according to claim 11, wherein the modulation blocks are distinct from one another.

14. The method according to claim 11, wherein the symmetrical modulation coefficients are jointly estimated.

15. The method according to claim 11, wherein the symmetrical modulation coefficients are estimated in the same position with respect to the carrier coefficient for each modulation block.

16. The method according to claim 11, wherein the symmetrical modulation coefficients are considered to be realisations of a multivariate heavy-tailed distribution.

17. The method according to claim 11, wherein the whitened vibratory spectrum is defined by the following formula:
$$y = {Φ}^{- 1} x + w$$
wherein:
Φ is a Fourier transform, Φ^{†}Φ=I_{N} and Φ^{†} is the conjugate transpose of the matrix Φ and I_{N} is the identity matrix of size N.
x∈C^{N} is the vector of unknown Fourier coefficients of the target signal x(n).
w is additive noise.

18. The method according to claim 11, wherein the modulation coefficients comprise real and imaginary parts which follow a Gaussian distribution with mean zero and covariance matrix τγ_{q}Σ with
γ_{q}≥0 is the mixing parameter according to a certain mixing distribution
Σ=Diag(v)⊗I₂∈R^{2B×2B} where ⊗ is the Kronecker product. I₂ the identity matrix of size 2×2 and v=[v_{I}, . . . , v_{B}]^{T}∈(R⁺)^{B}.

19. The method according to claims 17 and 18 taken in combination, wherein the modulation blocks are in the form of hierarchical models with
$$∀ b ∈ \{ 1 , … , B \} , {v}_{b} ∼ IG \{ {α}_{b} , {β}_{b} )$$
$$∀ q ∈ \{ 0 , … , Q \} , \sqrt{{γ}_{q}} \vert {ϕ}_{q} ∼ {C}^{+} ( 0 , \sqrt{{ϕ}_{q}} ) , \sqrt{{ϕ}_{q}} ∼ {C}^{+} ( 0 , 1 )$$
where IG(α_{b}, β_{b}) is the inverse Gamma distribution with positive constant parameters α_{b} and β_{b}C⁺(0,e) is the Cauchy half distribution with locus 0 and scale e.

20. The method according to claim 18, wherein the vector of the carrier coefficients is determined with a Gaussian prior such as x₀˜CN(0, τγ₀Diag(v)) where γ₀>0.
